(19) United States
(12) Patent Application Publication
(10) Pub. No.: US 2026/0181633 A1
(43) Pub. Date: Jun. 25, 2026

(54) VERIFICATION PROCEDURE FOR MACHINE LEARNING

(71) Applicant: Nokia Technologies Oy, Espoo (FI)

(72) Inventors: Oana-Elena BARBU, Aalborg (DK); István Zsolt KOVÁCS, Aalborg (DK); Sajad REZAIE, Aalborg (DK)

(73) Assignee: Nokia Technologies Oy, Espoo (FI)

(21) Appl. No.: 19/125,910

(22) PCT Filed: Oct. 11, 2023
(86) PCT No.: PCT/EP2023/078122

§ 371 Date: Apr. 30, 2025

(30) Foreign Application Priority Data
Nov. 4, 2022 (FI) 20225996

(51) Int. Cl. H04W 72/20; G06N 20/00; H04L 5/00; H04W 24/08; H04W 24/10; H04W 72/541

(52) U.S. Cl. CPC H04W 72/20; G06N 20/00; H04L 5/0051; H04W 24/08; H04W 24/10; H04W 72/541

(57) ABSTRACT

In some aspects, it is provided a method comprising, for example: carrying out, by the verifier entity, at least one auxiliary task using at least the at least one outcome indicated in the received information; determining, by the verifier entity and using at least one output of the at least one auxiliary task, a label for the at least one radio signal measurement associated with the at least one outcome, or determining, by the verifier entity and based on the at least one output of the at least one auxiliary task, the at least radio signal measurement associated with the at least one outcome is to be discarded; and transmitting the label and the at least one radio signal measurement to the first network node or the second network node to update the machine-learning model for the primary task.

### FIELD

The subject matter described herein relates to machine learning within a communication system.

### BACKGROUND

Artificial Intelligence (AI) or Machine Learning (ML) may be used with aspects of the air interface between a user equipment (UE, user device, terminal device, or a user device implemented as a system or a part of it, such as an XR system (augmented reality (AR), virtual reality (VR), and/or mixed reality (MR)) and a base station, such as next generation evolved Node B (gNB) type base station or other type of wireless access point. For example, the air interface may be augmented using AI/ML-based technology to provide channel state information (CSI) feedback compression, beam prediction, positioning accuracy, and/or the like. The AI/ML technology may be diverse to support various requirements on the gNB-UE collaboration levels. AI generally refers to a processor-based device's ability to emulate cognitive functions such as learning, problem solving, and/or the like, while ML generally refers to an application of AI via for example, ML models. Though the terms “AI” and “ML” are often used interchangeably, the following description refers to ML for clarity and consistency of explanation, but wherever ML is mentioned in an example, it comprises the use of AI (and vice versa, so when AI is mentioned, it comprises ML).

### BRIEF DESCRIPTION

In some aspects, there may be provided a method that comprises receiving, by a verifier entity and from a first network node, a configuration for at least labelling at least one radio signal measurement; receiving, by the verifier entity and from a second network node, information indicating at least one outcome of an inference of a machine learning model for a primary task associated with the at least one radio signal measurement; carrying out, by the verifier entity, at least one auxiliary task using at least the at least one outcome indicated in the received information; determining, by the verifier entity and using at least one output of the at least one auxiliary task, a label for the at least one radio signal measurement associated with the at least one outcome, or determining, by the verifier entity and based on the at least one output of the at least one auxiliary task, the at least radio signal measurement associated with the at least one outcome is to be discarded; and transmitting the label and the at least one radio signal measurement to the first network node or the second network node to update the machine-learning model for the primary task.

In some variations, one or more of the features disclosed herein including the following features can optionally be comprised in any feasible combination. The carrying out, by the verifier entity, may further comprise modifying the outcome, such that the output of the at least one auxiliary task using at least the modified outcome indicates a successful test of the modified outcome with the at least one radio signal measurement, wherein the modified outcome is used as the label for the at least one radio signal measurement. The at least one auxiliary task may comprise a machine learning task and/or a non-machine learning task. The at least one auxiliary task may comprise at least one task that uses, as input, at least one of the outcomes or the at least one radio signal measurement. The at least one auxiliary task may comprise a plurality of auxiliary tasks, wherein the plurality of auxiliary tasks are used in combination by the verifier entity to cross-validate the outcome to determine the label for the at least one radio signal measurement. The configuration for at least labelling at least one radio signal measurement may further comprise at least one of: an indication of whether all or a part of the at least one radio signal measurement is to be labelled; a configuration for the receiving the information indicating the outcome; information on the at least auxiliary task; and a configuration for transmitting the set comprising the label and the at least one radio signal measurement to the trainer entity. The first network node may comprise a trainer entity, and wherein the second network node comprises at least one of a user entity or the trainer entity. The verifier entity may be comprised in or comprise a gNB base station, and wherein the user entity may be comprised in or comprise a user equipment, and wherein the trainer entity may be comprised in or comprise a location management function. The determining, by the verifier entity, the at least one radio signal measurement to be discarded may further comprise transmitting the at least one radio signal measurement to the first network node or the second network node for a semi-supervised training procedure. The primary task may comprise one of a position estimation, a line of sight estimation of a signal source, or a beam selection.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram with an example of a cellular system including a trainer entity, a user entity, and a verifier entity, in accordance with some embodiments;

FIG. 2 depicts an example of a process for training and verifying a machine learning model, in accordance with some embodiments;

FIG. 3 depicts another example of a process for training and verifying a machine learning model, in accordance with some embodiments;

FIG. 4 depicts yet another example of a process for training and verifying a machine learning model, in accordance with some embodiments;

FIG. 5 depicts an example process at a verifier entity, in accordance with some embodiments;

FIG. 6 depicts an example of a network node, in accordance with some example embodiments; and

FIG. 7 depicts an example of an apparatus, in accordance with some example embodiments.

Like labels are used to refer to same or similar items in the drawings.

### DETAILED DESCRIPTION

With respect to the physical layer related to the radio access network (RAN) implementations of ML, there may be a need to specify a given ML model, the lifecycle management of the ML model (e.g., dataset construction for training), validation and test for the selected ML model and corresponding use cases, signalling, training and validation of the ML model, assistance information for the ML model, measurement, and monitoring, and/or feedback/reporting. With respect to protocols over the RAN, implementations of ML may specify a given ML model including aspects related to capability indication, configuration, and control procedures (e.g., training/inference), management of data and the ML model, and/or collaboration level specific specification impact of a given use case.

In some embodiments, there may be provided ML model training that uses a verification process to verify that an outcome (which is generated by an ML model as an output) while carrying out a primary task with an input of so-called “live” data, such as at least one radio signal measurements, corresponds to the live data input to the ML model. If verified, the live data is labeled with the associated outcome and transmitted to a training entity to enable use of the outcome and associated live data as training data of the ML model's primary task. As noted, the live data may correspond to data, such as radio signal measurement measurements (which may be carried out, generated, collected, or otherwise obtained) at for example the UE or another entity. To illustrate further, the live data may correspond to UE measurements of radio signal related measurements, such as channel input response (CIR) for a given Transmission/Reception Point (TRP) and/or the like. In this way, the verification allows using the live data as training data for supervised (and/or semi-supervised) training of the primary task of the ML model. As such, the training data (set, samples) used in the training may be increased with additional training data, which increases the diversity and volume of the training data and/or may also increase the performance and/or robustness of the inference of the primary task of the ML model.

It should be appreciated that the data used may be real-time or live data, or it may be any data usable for the purpose.

The primary task refers to the ML model's primary task (PT) while the ML model is carrying out an inference. The PT may vary based on use case. For example, an inference of an ML model's PT task may assist a UE with position estimation (e.g., determining the UE's position), line of sight (LOS) or non-LOS classification of a link to Transmission/Reception Point (TRP), beam selection, and/or the like. In some embodiments, the verification process carries out a non-PT (also referred to herein as an “auxiliary task”) to verify (e.g., test) that outcome and optionally or additionally its associated live data to determine whether to label the live data, such as at least one radio signal measurement, with the outcome (and treat the live data mapped to the outcome as verified and thus suitable for use in training of the ML model's primary task).

In the case of the PT being position estimation for example, the training may be carried out at for example a server or host (e.g., a central server, a central ML unit, and/or an edge server located (or accessed) at a radio access network node, such as the gNB). To illustrate by way of an example, a central ML unit may be a 5G network data analytics function (NWDAF) that provides data analytics including insights and actions to enhance for example position estimation. To illustrate further, the central ML unit may carry out training as follows. A set of data collection devices may be deployed (or selected) in certain locations. An example of such data collection devices are so-called positioning reference units (PRUs). The PRU refers to a device at a known locations (e.g., where the known locations can provide labels for use during training of an ML model). The PRUs may carry out measurements, and these measurements may then be used to generate correction data, which may be used to refine the position of one or more other UEs (e.g., target UEs) located in the same area as the PRUs, such that positioning accuracy can be increased. In this example, the PRUs server provide reference, labeled data for an ML model training data set. Although some of the examples refer to a PRU, other types of devices or network nodes may be used to collect data as well.

To illustrate further, the PRU(s) may conduct positioning measurements and report the measurements to the central ML unit. In addition, this central ML unit may emulate positioning measurements. Moreover, the central ML unit may receive (or be provided with) position measurements from other multiple sources (although at least some of these other sources might not be accurate). The central ML unit may then choose to combine the positioning measurements and the emulated position measurements from the different PRUs to train a localization ML framework. The ML framework may be deployed at network entities (also referred to herein as “host,” where a host may be of different types running ML processes including ML models). The host types may comprise, or be comprised in, a UE (e.g., the noted target UEs), a PRU, and/or a radio access network node, such as a gNB, and or a location management component (LMC) to enhance positioning accuracy.

In the case of ML model deployment to a UE or other entity for example, an issue relates to ensuring the training data (which is used to train an ML model) is diverse and available for training the ML model. However, collecting, and labelling train data may be burdensome with respect to training time (and associated latency of collecting the training data) and the computationally resources needed for the training. For example, there are limited processing resource at network nodes (e.g., a UE, a gNB, a location management function (LMF), or the like) that can measure and extract accurate training data (e.g., input data mapped to corresponding labeled output data) from new radio (e.g., 5G or New Radio, NR) measurements. Some ML models for use in the 3GPP cellular system (e.g., 5G and the like) may rely on inputs in the form of channel input response (CIR) estimates, but CIR is not a standard layer 1 key performance indicator (KPI) so the accuracy, availability, and/or acquisition of CIR measurements may not always be straightforward. Additionally, there may be a relatively large and burdensome computational and signalling overhead associated with setting up processes for generating, collecting, and/or labeling large training data (even when such processes are partly automated based on non-3GPP functionalities, digital-twins, ray tracing, and the like). Yet additionally, the radio resources for reporting large amounts of training data between UE and gNB are limited.

Given the noted issues with respect to limited resources, partial (also referred to as noisy) labelling of training data may be used and supervised (or semi-supervised) ML learning may be implemented wherein the training of the ML model receives, as an input, partly labelled training data. The partly labeled training data refers to only a subset (but not all) of the training data being labeled for training of the ML model. For example, a portion of the training data may be labeled, while another portion is not labeled. However, there is no mechanism or process within the 3GPP for handling partly labeled training data for training an ML model in a supervised (or semi-supervised) ML model.

In some embodiments, there is provided a process for using unlabeled live data, such radio signal measurements, as an input to train an ML model to carry out a primary task (PT). This unlabeled data may be considered “live” in the sense that it is data that is measured (or otherwise obtained) by the UE, for example as a part of normal radio cell measurements, such as such as signal samples, signal quality measurements, channel measurements, or other types of data/signals obtained by the UE (e.g., which may be obtained while the UE is engaged in some other data, measurement, or positioning session). For example, the radio signal measurement may comprise a CIR measurement obtained as part of air interface measurement operations of the UE, rather than as a specific ML directed training task at the UE.

During a learning phase, an ML model may learn to carry out a primary task, and the trained ML model may be used (during an inference phase) to generate an outcome of the primary task being carried out by the ML model, such as positioning, compression, beam selection, etc. For example, a training dataset including labeled data may be enriched by adding to the training data the live data that, due to the verification processes disclosed herein, is labelled to enable use in ML model training. As such, the training data is enlarged, which may increase the diversity of the training data set, may increase the performance of the ML model's in carrying out the primary task, and/or may reduce the need to collect (via dedicated processes) massive amounts of labelled training data for training the ML model.

In some embodiments, there is provided a signalling exchange which may be used as part of (or, e.g., to enable) training of an ML model for a given task, which is referred to herein as a primary task (PT). For example, the training of the ML model for the primary task may comprise converting unlabeled live data (e.g., radio signal measurement(s) or other data collected from or obtained by (current) measurements being carried out by a UE or provided to the UE by for example another UE) to labelled real-time or live data (e.g., radio signal measurement labeled with for example an outcome) that can be used as training data to train the ML model to carry out the PT. This process may occur via a network node (such as an NR entity operating as a “verifier”) that verifies the outcome (such as an ML model output) given an input of the unlabeled real-time or live data. A verifier may as well locate in a server, or host such as is an edge cloud unit, or being available for, or operationally coupled via a radio connection to any apparatus such as a user device (UE), or it may be a part of a system controlled by a user device. A verifier may be a logical unit.

The labeling may thus indicate a verification of the (live) data input (e.g., a radio signal measurement data sample) to the ML model and the associated outcome of the inference of the PT of the ML model, wherein the verification may be carried out with a non-PT, such as an auxiliary task. This non-PT (or auxiliary task) may comprise at least one ML model related task and/or at least one non-ML task.

In some of the examples described herein, the signalling exchange is described with respect to at least a trainer entity, a user entity, and a verifier entity. For example, the trainer entity (also referred to herein as a new radio-primary task trainer, NR-PT-trainer, or “trainer” for short) refers to an NR (e.g., 5G) entity that uses labelled training data to train an ML model to solve a given PT. Although the trainer may be implemented at a variety of NR entities, in some examples described herein, the trainer may comprise or be comprised in a gNB type base station, a location management function (LMF), and/or other nodes, functions, or entities in the radio access network, 5G core network, and/or at other locations (e.g., as a cloud service). The user entity (also referred to herein as a new radio-primary task user, NR-PT-user, or “user” for short) refers to NR entity that uses the trained ML model on so-called live data (e.g., radio signal measurement(s) collected, measured, or provided to the user) and produces a solution, also called the outcome for the PT. Although the user may be implemented at a variety of NR entities, in some examples described herein, the user may comprise or be comprised in a UE, although the user may also comprise or be comprised in a gNB type base station, a Transmit/Receive Point (TRP), a location management function (LMF), and/or other nodes, functions, or entities in the radio access network, 5G core network, and/or at other locations (e.g., as a cloud service). Moreover, the verifier entity (also referred to herein as a new radio-primary task verifier, NR-PT-verifier, or “verifier” for short) refers to NR entity that receives (e.g., obtains) at least the outcome from the NR-PT-user.

In some embodiments, the verifier entity uses an outcome (which is, e.g. output by an inference of an ML model carrying out the PT) to solve a non-PT, or auxiliary task. For example, the non-PT may verify the accuracy of the outcome of the ML model. If the non-PT is solved successfully (or, e.g., live data combined with the outcome generates a result that is deemed as correct by the verifier), the verifier entity validates the outcome and labels the outcome as verified (e.g., by indicating the outcome is verified and/or the mapping the live data input to the outcome), so the outcome mapped to the live data input (e.g., radio signal measurement(s)) may be transferred to a training data for training the PT of the ML model. If however the non-PT is not solved successfully (e.g., the live data combined with the outcome generates a result of the non-PT that is deemed incorrect), the verifier entity may iterate by modifying the outcome to determine if the non-PT can be solved successfully. If successfully solved, the modified outcome may be used as the label for the live data input (e.g., the radio signal measurement(s)). In this way, the verifier entity can label the unlabeled live data with its (or modified) outcome, such that the live data is labeled with the outcome or modified outcome. If the verifier cannot successfully verify the outcome with the live data, the live data (e.g., the radio signal measurement(s)) may be discarded and/or sent to another node where the live data (which has not been labeled or verified) might be useful a semi-supervised training procedure.

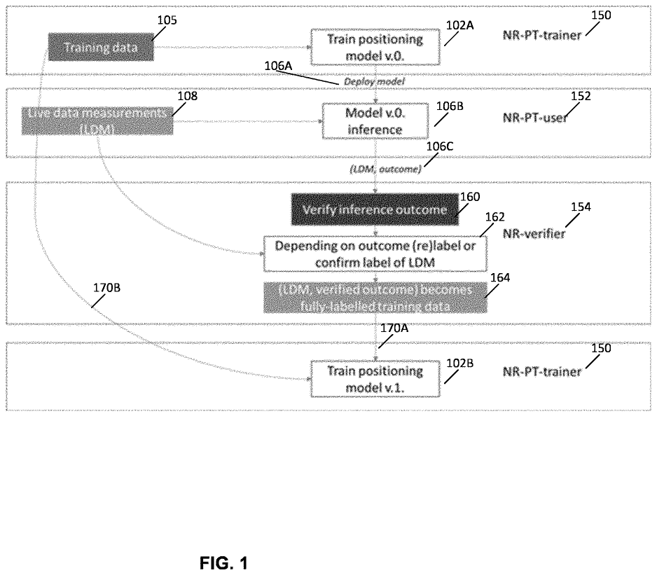

FIG. 1 depicts a block diagram with an example of a process among a trainer entity 150 (labeled NR-PT-trainer, or “trainer” for short), a user entity 152 (labeled NR-PT-user, or “user” for short), and a verifier entity 154 (labeled NR-PT-verifier, or “verifier” for short), in accordance with some embodiments. The example process of FIG. 1 refers to a primary task (PT) of position estimation for the ML model being trained for inference, but the process of FIG. 1 may be used for with other types of 5G related primary tasks of an ML model for other use cases, such as line of sight (LOS)/non-LOS classification, beam selection, and/or the like.

At 102A, the trainer entity 150 may train an ML model for a task, such as a primary task (PT), using a first set of training data 105, in accordance with some embodiments. The ML model may be trained to carry out the PT (which in this example is “position estimation,” although the PT of the ML model may be another type of task, such as beam selection, LOS/NLOS selection, a classifier, a regressor, and/or the like). Moreover, the ML model (which in the example of FIG. 1 is labeled as PT model v.0) may have an associated indication of the version of the ML model, so as different versions of the ML model may be identified. The training data 105 may be labeled training data, so in the training data an input is mapped to an output labeled with the desired outcome, so that the training phase can learn the ML model parameters to yield the output/outcome given the input.

At 106A, the ML model (e.g., PT model v.0) may be deployed to an NR entity, such as the user entity 152 (labeled NR-PT-user). For example, the ML model trained at 102A may be deployed (e.g., sent, transmitted, and/or the like) by deploying the parameters (e.g., weights and the like) of the ML model and/or deploying metadata (e.g., other information to enable use) of the ML model. Although FIG. 1 depicts the ML model being deployed at 106C by the trainer 150 to the user entity 152, other devices such a ML orchestrator may deploy the ML model.

At 106B, the user entity 152 may use live data, such as one or more radio signal measurements, 108 as input to the ML model and may generate an outcome given the input. In the example of FIG. 1, the outcome 106C (which is output by the inference of the ML model's PT) may comprise at least the outcome. Alternatively, or additionally, the outcome may comprise (or identify a location or an identity of) the input, such as the live data (e.g., the radio signal measurement(s)) that generated the outcome at 106C. The live data (which is referred to as live data measurements, LDM, at FIG. 1) may correspond to live data that is measured, generated, collected, reported, and/or the like by the user entity. For example, the user entity may carry out a CIR per TRP measurement as part of another (e.g., non-ML session) session of the user entity. Examples of live data comprise channel input response (CIR) estimates for a TRP, channel state information reference signal (CSI-RS) measurements, Reference Signal Received Power (RSRP), angle of arrival (AoA), time of arrival (ToA), and/or other measurements made, generated, or received by the user entity with respect to the air interface.

It should be appreciated, though, that data (samples) used are not necessarily live or real-time data samples, even abbreviation LDM is used in the examples for the sake of brevity. Any data suitable for the purpose is usable. In radio communication, measurement data (one or more samples) is obtained by radio signal measurements.

In some embodiments, the trainer entity 150 may indicate to the user entity 152 to store the live data, such as live data measurements 108, used as an input to the ML model and may indicate to the user entity to store the live data measurements along with, for example, a time stamp or other indication to locate or identify the live data measurements. For example, the one or more live data measurements provided as an input to the ML model 106B may generate a corresponding outcome for the ML model's PT. In this example, each time stamp may be mapped to the live data measurement input and the corresponding outcome, so in this example the LDM, outcome, and time stamp are stored over a period of time.

In some embodiments, the user entity 152 may at 106C transfer (e.g., send, transmit, provide, and/or the like) to the verifier entity 154 a combination of the set of (live) data measurement(s) (LDM) 108, the outcome, and/or the time stamp. When received, the verifier entity may then carry out a task, such as a non-PT (also referred to herein as an auxiliary task), to verify at 160 the outcome that is mapped to the corresponding LDM input (e.g., the radio signal measurement(s)). As noted, the transfer may comprise outcome, the mapped set of the LDM and outcome, or the mapped set of the LDM, outcome, and time stamp. For example, the user entity 152 may transfer to the verifier entity 154 the LDM mapped to the corresponding outcome as well as the time stamp at 106C. Alternatively, or additionally, the LDM portion is not provided to the verifier entity at 106C (e.g., the outcome is provided with an indication of the corresponding LDM input to enable identifying and/or retrieving the LDM input). Alternatively, or additionally, the user entity may transfer to the verifier entity only the LDM and mapped outcome, without time stamp.

In some embodiments, the verifier entity 154 may verify at 160 the outcome given the input, such as the LDM. For example, the verifier entity may test the outcome given the LDM using a non-PT (or an auxiliary task) that is used to test or verify the outcome given the LDM input. If the test is successful, this indicates that the ML model properly inferred the outcome given the LDM, so the verifier entity may add a label to the LDM (e.g., by adding the outcome to the LDM input and/or indicating that the outcome of the LDM input is verified).

If, however, the non-PT (or an auxiliary task) is unsuccessful in verifying the outcome given the input LDM, the verifier entity 154 may deem the outcome at 106C as incorrect, so the verifier entity will not label or verify the LDM and corresponding outcome.

Alternatively, or additionally, when the non-PT (or the auxiliary task) is unsuccessful, the verifier entity 154 may modify the outcome by for example labelling the LDM sample with a different outcome, such as the opposite outcome in the case of for example when the outcome is a binary outcome (e.g., if the PT is a binary classification task, then the label mapped to the LDM input sample can be the opposite of what is indicated by the outcome at 106C).

Alternatively, or additionally, when the non-PT (or the auxiliary task) is unsuccessful, the verifier entity 154 may iteratively modify the initial outcome provided at 106C until the verification testing at 160 indicates success. The modified outcome may then be used as a label for the LDM input. For example, the verifier entity may iteratively (e.g., repeatedly) apply a selected function f to the outcome provided at 106C to generate the modified outcome, which is then verified via the non-PT at 160. If the verification of the modified outcome is successful, the modified outcome is then used as a label for the LDM input.

Alternatively, or additionally, when the non-PT is unsuccessful and/or the verifier entity does not have a way to modify (and/or verify) the original outcome provided at 106C, the verifier entity might discard the set or pair of, for example, LDM and outcome of the PT. Alternatively, or additionally, when the non-PT is unsuccessful and/or the verifier entity does not have a way to modify (and/or verify) the original outcome provided at 106C, the verifier entity might forward the LDM (live or real-time data) to enable another node to use the unlabeled LDM in semi-supervised learning of the ML model.

At 164, the verifier entity 154 may use the results of the verification at 160 and/or outcome relabeling 162 to form a labeled set of training data, which can be transferred or used alone or in combination with training data 105 to train the inference of the PT of the ML model. At 170A for example, the LDM input and labeled outcome pair may transferred to the trainer entity 150, so that the verified, LDM input and labeled outcome pair/data may be used as an input (along with other training data such as training data 105) to train (or retrain) at 102B an ML model. Alternatively, or additionally, this verified data (LDM, verified outcome) may be added to the original training data 105 to increase the diversity and quantity of training data. To illustrate further, the LDMs and their labeled outcomes (e.g., LDM1, outcome1; LDM2, opposite-outcome2; and LDM3, modified-outcome3) may be forwarded at 170A for use in training of the ML model and/or sent to the trainer 150 to augment the training data 105 with additional training data. Alternatively, or additionally, the non-verified LDMs may also be forwarded to the trainer entity 150 to enable the trainer to attempt to identify a label in a semi-supervised training procedure, for example.

At 102B, the trainer entity 150 may use the new training data (which is received at 170A) with the initial training data 105 to train another version (e.g., v.1) of the inference of the PT of the ML model. The trainer entity may replace the ML model (e.g., v.0) with an updated version of the ML model (e.g., PT model v.1) for subsequent use by the user entity 152 to carry out the PT.

The non-PT (auxiliary task) may be a ML assisted (or enabled) task (or function) that verifies the LDM and outcome (or function) and/or a non-ML based task (or function) that verifies the LDM and outcome. The non-PT used by the verifier entity 154 to verify at 160 may be a task (e.g., a procedure) that uses, as input, the outcome generated by user entity and at least one of the following: (1) at least one of the inputs of the LDM used by the ML model (PT model v.0); (2) other types of measurements for the same entity and provide as (one of the) outputs a metric which can be used directly or indirectly to verify the validity of the ML model inference; or a combination of (1) and (2). Additionally, several different non-PTs can be used combined by verifier entity 154, in which case a cross-validation may be used as well in the verification and labelling of the one or more data samples (in many real-world applications a plenty of data samples are needed for targeted performance accuracy).

As noted, the ML model may be trained to carry out a variety of primary tasks (PTs) associated with the air interface, and then the trained ML model may be used in an inference phase to carry out the PT. For example, the primary task (PT) of the ML model may be a line of sight (LOS) and/or non-LOS classification task. When this is the case for example, the trainer entity 150 may comprise or be comprised in a UE, a TRP, or LMF (or a location management component in the RAN); the user entity 152 may comprise or be comprised in the UE (e.g., for DL positioning) or the TRP (e.g., for UL positioning). The live data measurements, may comprise radio signal measurements, such as CIR estimates per TRP. The outcome may comprise a LOS binary flag per TRP (e.g., a LOS flag equals 1 when there is LOS towards a respective TRP or LOS flag is 0 when there is no LOS toward a respective TRP). For example, the verifier entity 154 may correspond to a NG RAN entity (e.g., the gNB) that manages the non-PT, which in this example is a beam selection task. The beam selection may use the reported outcome (e.g., the LOS flag/indicator per a signal source such as a TRP) with other assistance information to select (and/or predict) a beamed link between transmitters. The verifier entity 154 may carry out a verification (using, e.g., a non-PT/auxiliary task) by comparing the predicted beam pair (e.g., predicted using the radio signal measurement and/or outcome) with an expected or optimal beam pair (e.g., selected with exhaustively search over all the beam pairs) and their signal levels to verify or refute the outcome (LOS flag equals 1 when there is LOS towards a respective TRP) associated with the sample LDM (e.g., CIR per TRP).

Alternatively, or additionally, the PT may be position estimation. In this example, the trainer entity 150 may comprise or be comprised in a UE or a LMC and/or LMF; the user entity 152 may comprise or be comprised in a UE (for UE-based positioning) or the LMF (in UE-assisted positioning). In this example, the LDM may comprise radio signal measurement, such as CIR per TRP, while the outcome may comprise the (x, y) location of the UE. The verifier entity may comprise or be comprised in an NG RAN element that solves the non-PT of beam management. For example, the beam selection may use the reported outcome (e.g., UE location) and/or may use other assistance information to select (and/or predict) a beamed link between transmitters. For example, the verifier entity may compare the predicted beam pair (which is predicted, e.g., using the radio signal measurement and/or outcome) with the expected or optimal beam pair (selected with, e.g., an exhaustive search over all the beam pairs) and their signal levels to verify or refute the outcome associated to the sample. For example, the outcome can be verified (using, e.g., a non-PT or auxiliary task) when there is less than a threshold loss amount (e.g., 3 dB) in the measured signal level with the selected beam pair compared to the signal level with the expected/optimal beam pair; otherwise the outcome is not verified (e.g., refuted).

Alternatively, or additionally, the PT may be beam selection. In this example, the trainer entity may comprise or be comprised in the NG-RAN, for an ML model v.0 deployed in the UE (or split between UE and NG-RAN). The user entity may comprise or be comprised in a UE (e.g., when PT model v.0 is deployed in the UE only). The LDM may comprise radio signal measurements, such as CSI-RS measurements and beam Reference Signal Received Power (RSRP) measurements, with the outcome corresponding to beam ID. The verifier entity may comprise or be comprised in the NG-RAN and use a positioning algorithm/function running in the LMF as the non-PT. The positioning algorithm may use, as input, for example, CIR, time of arrival (ToA), angle of arrival (AoA), and/or LoS/NLOS. Based on the UE location information (and/or with TRP/gNB location, and/or a radio environmental map), the verifier entity may (using, e.g., a non-PT or auxiliary task) estimate the optimal beam selection (e.g., beam ID) for the UE (or the UE-gNB beam pair).

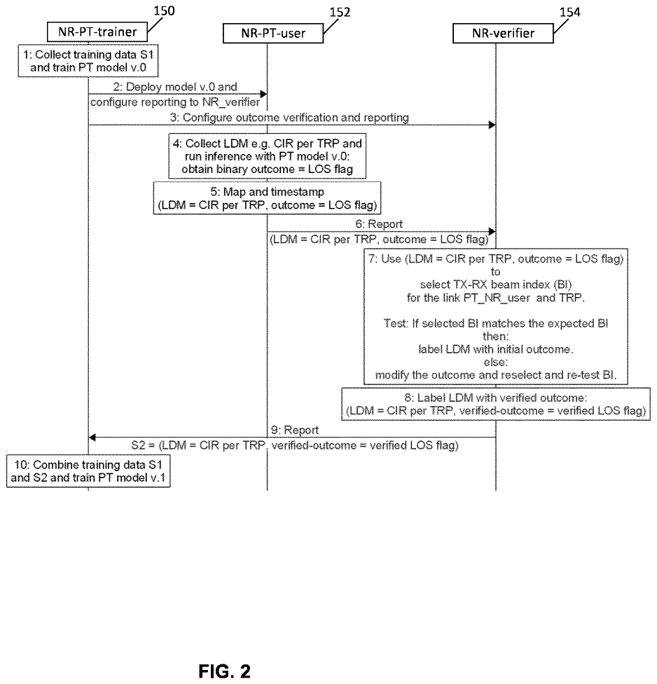

FIG. 2 depicts another example of a process including the trainer entity 150 (e.g., NR-PT-trainer), the user entity 152 (e.g., NR-PT-user), and the verifier entity 154 (e.g., NR-verifier), in accordance with some embodiments. In the example of FIG. 2, the primary task (PT) relates to line of sight (LOS) and/or non-LOS (NLOS) classification, which may be used in beam selection. In the example described below, the trainer entity may be comprised in a LMF or LMC, the user entity may be comprised in a UE, and the verifier entity may be comprised in a base station, such as a gNB, although other network nodes/entities may be implemented as well as the trainer, user, and/or verifier entities,

At 1, the trainer entity (or trainer, for short) 150 may collect a first set (S1, one or more samples) of training data and train the ML model (e.g., PT model v.0) to carries out its primary task (PT), in accordance with some embodiments. For example, the trainer may start training the ML model to form an initial version of the ML model, such as PT model v.0, using the first set of training data (S1), which may comprise LOS detector data (e.g., CIR per TRP, and LOS binary flag per TRP) available at (or accessible by) the trainer. The trainer may comprise or be comprised in the LMF. Alternatively, or additionally, the LMF may provide the training data in the form of LOS (and/or NLOS) detector data.

At 2, the trainer 150 may deploy (e.g., send, transmit, provide, make accessible, and/or the like) to the user entity 152 (e.g., NR-PT-user, or user, for short) the ML model trained by the trainer 150, in accordance with some embodiments. Moreover, the deployment of the ML model may comprise assistance information. For example, the assistance information may indicate to the user 152 (which may be comprised in a UE, for example), a configuration of a report that the user (e.g. UE) should send as feedback to the verifier entity (NR-verifier, or verifier, for short which may be comprised in a gNB). The configuration provided by the assistance information may comprise one or more of the following: a minimum number (e.g., quantity) of outcomes before reporting to the verifier; what LDM to report (if any) to the verifier; and when to send the report (and/or through which interface) to the verifier. Although FIG. 2 depicts the trainer deployment, other entities may deploy the trained ML model to the user entity. Moreover, to deploy the ML model, the parameters (e.g., weights of the ML model and the like) are provided (e.g., sent, transmitted, and/or the like) to the user entity. To illustrate further, the trainer (which may be comprised in an LMF or LMC) may transmit assistance data to the user via for example an LPP (LTE positing protocol) message (or information element), which comprises the configuration of the report that the user should send to the verifier.

At 3, the trainer 150 may also configure the verifier 154, in accordance with some embodiments. For example, the message transmitted (or sent) at 3 may comprise a configuration for at least the labelling of at least one radio signal measurement. For example, the message at 3 may comprise assistance information, and the assistance information may comprise the configuration for at least the labelling of at least one radio signal measurement. This configuration for at least the labelling of at least one radio signal measurement may comprise one or more of the following: a request to verify outcomes reported from one or more users (e.g., NR-PT-users) and/or a request to report to the trainer (e.g., NR-PT-trainer) the results of the ML model verification process. To illustrate further, the trainer (which may comprise an LMF (or LMC) may send at 3 to the verifier (e.g., gNB) an NR Positioning Protocol A (NRPPa) measurement report, although other types of messages may be used to report the input LDM and verified outcome. In this example, NR Positioning Protocol A (NRPPa) measurement report may indicate a request to accept and verify outcome reports from a list of NR-PT-users and/or a request to report to the NR-PT-trainer the results of the verification process. Alternatively, or additionally, the configuration may indicate a configuration, such as a format, for the receiving the information indicating the outcome. Alternatively, or additionally, the configuration may comprise information on the at least auxiliary task, such as an indication of which auxiliary task should be used by the verifier entity when verifying the outcome. Alternatively, or additionally, the configuration may comprise a configuration for transmitting the set comprising the label and the at least one radio signal measurement to, for example, the trainer entity to enable the trainer entity to use the set to train the PT of the ML model. Alternatively, or additionally, the configuration may comprise a list of network nodes, such as user entities or other types of entities, that the verifier entity should (or is allowed) to receive outcomes and associated radio signal measurement for verification using at least one auxiliary task. Alternatively, or additionally, the trainer entity may comprise a first network node, which may be associated with training the ML model's primary task and/or providing training data for that training. Alternatively, or additionally, the verifier entity may be comprised in or comprise a gNB base station. Alternatively, or additionally, the user entity may be comprised in or comprise a user equipment. Alternatively, or additionally, the trainer entity may be comprised in or comprise a location management function. Alternatively, or additionally, the primary task of the inference of the ML model may comprise a position estimation, a line of sight estimation/detection of a signal source, and/or a beam selection.

At 4, the user 152 may execute the ML model (e.g., PT model v.0) using the received input data, and the ML model produces an output, such as an outcome, in accordance with some embodiments. For example, the input data may comprise LDM, such as at least one radio signal measurement (e.g., CIR per a TRP and/or the like) and the corresponding outcome may comprise LOS flag to the TRP.

At 5, the user 152 may map the input data to an outcome (which is caused by the input data) of the ML model, in accordance with some embodiments. For example, the input LDM values (CIR per a TRP) may mapped to corresponding outcome such as an LOS flag. Alternatively, or additionally, the user 152 may apply a time stamp to the mapped set of input data and outcome.

At 6, the user 152 may report (e.g., transmit, send, provide, and/or the like) the mapped set (e.g., input LDM value(s), LOS flag(s), and/or time stamp(s)) to the verifier 154 as indicated (or instructed) by for example the message at 3, in accordance with some embodiments. For example, the verifier may receive from the user information indicative of the outcome of the ML model's inference and an associated indication of an input LDM (which output the outcome). This indication may comprise a time stamp (mapped or associated with the outcome and associated input LDM), an identifier that enables identifying the associated input LDM, and/or the input LDM itself. The reporting may be carried by an uplink (UL) channel, such as the UL shared channel (SCH), an UL short data transmission (SDT), or carried via RRC signaling.

At 7, the verifier 154 may use the information received at 6 (e.g., the outcome and the associated input LDM) to verify the outcome given the input LDM using a non-PT, such as an auxiliary task. In the example of 7, the auxiliary task comprises selecting, using the outcome given the input LDM, a best TX-RX beam pair (which may be identified by a beam index (BI) between the respective signal source (TRP) and the UE. If for example the selected TX-RX beam pair matches an expected beam pair, the LOS outcome is verified. Otherwise, the LOS outcome is modified (e.g. set to the opposite value) and re-verified. In this example, the expected beam pair is a beam pair for which the signal to interference and noise ratio (SINR) is higher than a given threshold. Alternatively, or additionally, the expected beam pair may be identified via an exhaustive search for beam pairs. To illustrate further, the verifier entity may receive information indicating an outcome of an inference of a machine learning model for a primary task associated with the at least one radio signal measurement. The verifier entity 154 may receive the outcome of the inference of the ML model's primary task given an associated input of the at least one radio signal measurement. The outcome may be received with the associated at least one radio signal measurement, or the outcome may be received with an indication of the identity of the at least one radio signal measurement to enable the verifier entity to access or fetch the at least one radio signal measurement. Moreover, the outcome may be received as an indication to enable the verifier entity to access or fetch the outcome.

At 8, when the outcome is verified using the non-PT (or auxiliary task), the live data measurement, such as the radio signal measurement (e.g., CIR per TRP) reported at 6 and verified at 7 is labeled with the respective outcome. In other words, the output of the auxiliary task may be used to determine a label for at least one radio signal measurement associated with the outcome of the ML model. Given the verification, the input LDM (e.g., CIR per TRP) is labeled with the outcome (e.g., LOS Flag 1), which has been verified using the non-PT/auxiliary task, so the input LDM (e.g., CIR per TRP) and the outcome (e.g., LOS Flag 1) can be transferred to a training data and/or used during training of the PT of the ML model. Alternatively, or additionally, the LDM, outcome pair may comprise a flag or indication of the verification (e.g., verified LOS Flag 1).

At 9, the verifier 154 may send to the trainer 150 the labeled LDM (S2). For example, the verifier may send the input LDM (e.g., CIR per TRP) and the label outcome (which has been verified) to the trainer, so that the input LDM and verified outcome can be used to train an ML model and/or to augment the training data set. The report at 9 may be sent via an NR Positioning Protocol A (NRPPa) measurement report, although other types of messages may be used to report the input LDM and verified outcome.

At 10, the trainer 150 may comprise the labeled LDM training data (S2) provided at 9 by the verifier 154 with the original training data (S1), so the aggregate training data (S1 and S2) can be used to train the ML model (e.g., PT model v.0) to form another ML model (e.g., PT model version v.1). For example, the updated or second ML model (e.g., PT model version v.1) may be further trained as in FIG. 2 and/or provided to an entity, such as a user entity, for carrying out the respective PT task (e.g., LOS and/or NLOS classification) during an inference phase of the updated or second ML model.

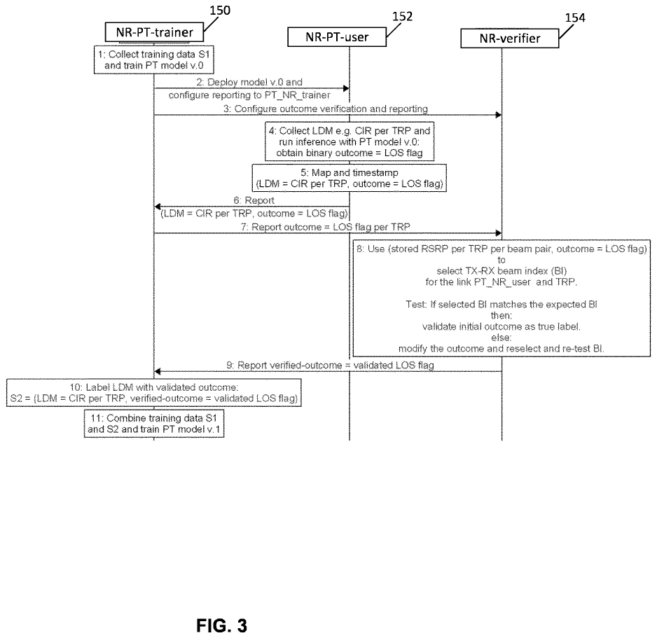

FIG. 3 depicts another example of a process among the trainer 150 (labeled NR-PT-trainer), the user 152 (labeled NR-PT-user, and the verifier 154, in accordance with some embodiments. FIG. 3 is similar to FIG. 2 in some respects but in the process of FIG. 3 the outcome (which in this example is the LOS NLOS) is reported by the user entity (NR-PT-user) and used by the verifier (NR-verifier). This may reduce the signalling overhead between the NR-PT-user and NR-verifier (message 7) and NR-verifier and NR-PT-trainer (message 9) but may require the NR-verifier to have a way of obtaining other channel information (in addition to the already reported LOS flag) required to run the beam selection.

Referring to FIG. 3 at 2 for example, the trainer 150 may deploy to the user entity 152 (the ML model trained by the trainer 150). And the deployment of the ML model may comprise assistance information being provided to the user entity. But unlike FIG. 2, the reporting (and configuration of the reporting) is directed to the trainer 150.

Referring to FIG. 3 at 6, the user 152 may report the mapped set (e.g., input LDM value(s), LOS flag(s), and/or time stamp(s) to the trainer 150, which may be indicated (or instructed) by the assistance information provided by the trainer to the user. The reporting may be carried by an uplink (UL) channel, such as the UL shared channel (SCH), an UL short data transmission (SDT), or carried via radio resource control (RRC) signaling.

Referring to FIG. 3 at 7, the trainer 150 may then report to the verifier 154 the outcome, such as the LOS flag per TRP. Referring to FIG. 3 at 9, the verifier 154 may report to the trainer 150 the verified outcomes (e.g., the validated LOS flag).

Referring to FIG. 3 at 10, the trainer 150 may then label the LDM input (e.g., CIR per TRP) with the validated outcome provided at FIG. 3 at 9. The input LDM (e.g., CIR per TRP) and the label comprising the verified outcome (e.g., verified LOS Flag 1) may then be used train, at 11 of FIG. 3, an ML model using the original training data (S1) and the newly labeled dataset (S2) of input LDM (e.g., CIR per TRP) and label comprising the verified outcome (e.g., verified LOS Flag). When the ML model is trained at 11 (FIG. 3) using the augmented training set of S1 and S2, another version of the ML model (e.g., PT model version v.1) may be generated. PT model version v.1 may be further trained as in FIG. 3 and/or provided to an entity, such as a user entity, for carrying out LOS/NLOS classification during an inference phase of the updated or second ML model.

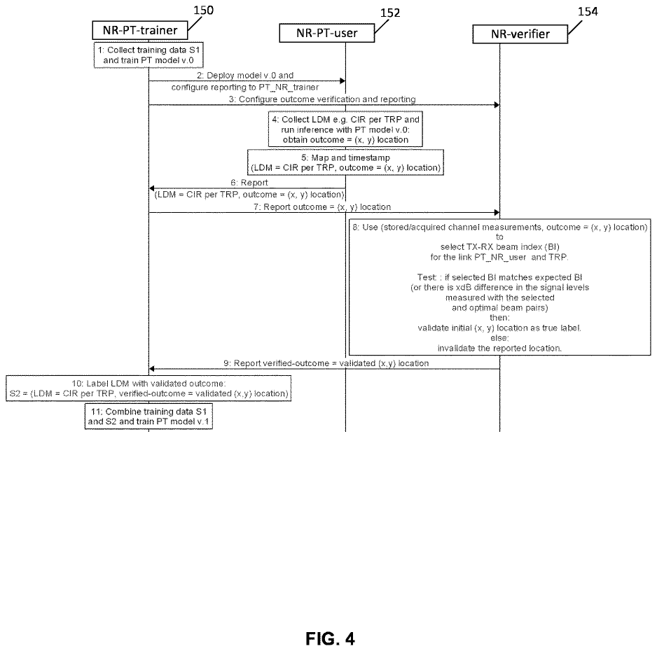

FIG. 4 depicts another example of a process among the trainer 150 (labeled NR-PT-trainer), the user 152 (labeled NR-PT-user, and the verifier 154, in accordance with some embodiments. FIG. 4 is similar to FIG. 3 in some respects but in the process of FIG. 4 has as a primary task (PT) of the ML model (PT model v.0) UE position estimation rather than the LOS/NLOS classification PT of FIG. 3. Referring to FIG. 4 at 4-10, the input LDM comprises CIR per TRP, while the outcome comprises a location (e.g., x, y) of the user. As such, the reported outcome at 7 (FIG. 4) is the location (e.g., x, y) of the user, the reported verified outcome at 9 (FIG. 9) is the validated x,y location of the user, for example. And, the labeling at 10 (FIG. 4) (used the validated outcome of a (x,y) location.

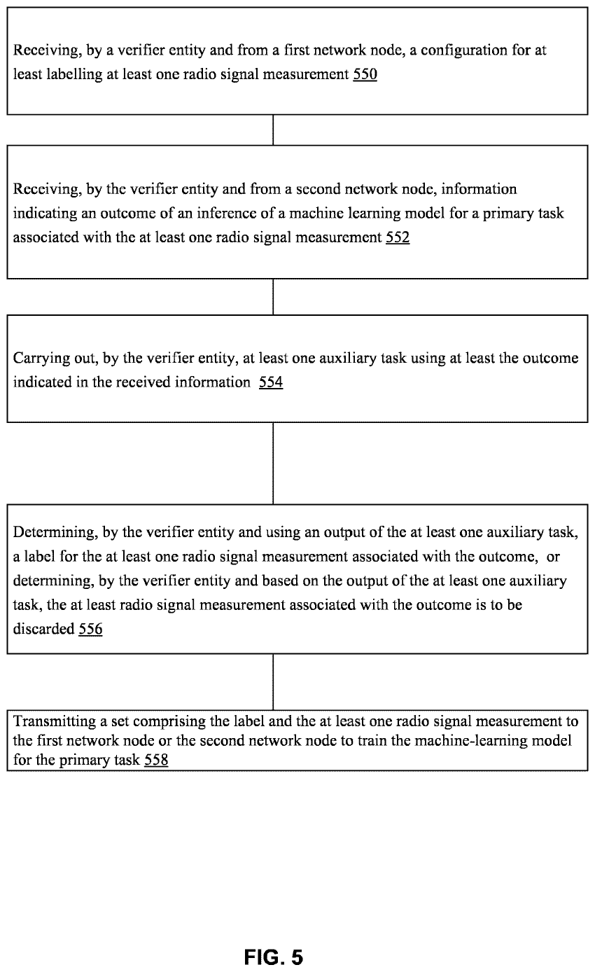

FIG. 5 depicts an example of a process that may be carried out at a verifier entity, in accordance with some embodiments.

At 550, a verifier entity may receive, from a first network node, a configuration for at least labelling at least one radio signal measurement, in accordance with some embodiments. For example, the verifier entity, such as verifier entity 154, may receive the configuration as an indication of whether all or a part of the at least one radio signal measurement is to be labelled. Referring to FIGS. 2-4 at 3 for example, the configuration may indicate whether a radio signal measurement, such as LDM or other type of measurement, provided to the verifier entity is be labeled with an outcome to enable the set of the radio signal measurement and outcome to be used in training at least one primary task (PT) the ML model. Alternatively, or additionally, the configuration may indicate a configuration, such as a format, for the receiving the information indicating the outcome. Alternatively, or additionally, the configuration may comprise information on the at least auxiliary task, such as an indication of which auxiliary task should be used by the verifier entity when verifying the outcome. Alternatively, or additionally, the configuration may comprise a configuration for transmitting the set comprising the label and the at least one radio signal measurement to, for example, the trainer entity to enable the trainer entity to use the set to train the PT of the ML model. Alternatively, or additionally, the configuration may comprise a list of network nodes, such as user entities or other types of entities, that the verifier entity should (or is allowed) to receive outcomes and associated radio signal measurement for verification using at least one auxiliary task. Alternatively, or additionally, the first network node may comprise a trainer entity, which may be associated with training the ML model's primary task and/or providing training data for that training. Alternatively, or additionally, the verifier entity may be comprised in or comprise a gNB base station.

At 552, the verifier entity may receive, from a second network node, information indicating at least one outcome of an inference of a machine learning model for a primary task (PT) associated with the at least one radio signal measurement, in accordance with some embodiments. Referring to the examples of FIG. 1 at 106C, FIG. 2 at 6, and FIGS. 3-4 at 7, the verifier entity, such as verifier entity 154, may receive the outcome of the inference of the ML model's primary task given an associated input of the at least one radio signal measurement. As noted, the outcome may be received with the associated at least one radio signal measurement, or the outcome may be received with an indication, such as a pointer, address, time stamp, or other indicator of the identity of the at least one radio signal measurement to enable the verifier entity to access or fetch the at least one radio signal measurement. Likewise, the outcome may be received as an indication as well (e.g., as a pointer, address, or other indicator of the identity of the outcome) to enable the verifier entity to access or fetch the outcome. Alternatively, or additionally, the first network node may comprise a trainer entity, which may be associated with training the ML model's primary task and/or providing training data for that training. The second network nodes may comprise a user entity (e.g., as noted at FIG. 2 at 6) or the trainer entity (e.g., as noted at FIG. 3 at 7).

At 554, the verifier entity may carry out at least one auxiliary task (non-PT task) using the at least the outcome indicated in the received information, in accordance with some embodiments. Referring to the examples of FIG. 1 at 160, FIG. 2 at 7, and FIGS. 3-4 at 8, the verifier entity, such as verifier entity 154, may carry out (e.g., perform, execute a computer program code) at least one auxiliary task using at least the outcome (which was indicated or received at 552). To illustrate further, the at least one auxiliary task may be a ML task and/or a non-ML task which can be used to verify (e.g., test) the at least one radio signal measurement (e.g., that the at least one radio signal measurement does indeed cause the outcome of the inference of the PT of the ML model). In the example of FIG. 2 at 7, the auxiliary task comprises selecting, using the outcome given the input at least one radio signal measurement, a best TX-RX beam pair (which may be identified by a beam index (BI)) between the respective signal source (TRP) and the UE.

At 556, the verifier entity may determine, using at least one output of the at least one auxiliary task, a label for the at least one radio signal measurement associated with the at least one outcome, or determine, based on the output of the at least one auxiliary task, the at least radio signal measurement associated with the at least one outcome is to be discarded, in accordance with some embodiments. Moreover, the at least one auxiliary task may comprise at least one task having an input of the at least one of the outcomes and/or the at least one radio signal measurement. Referring again to the example of FIG. 2 at 7, the verifier may, using an auxiliary task, determine a label by for example mapping the outcome to the at least one radio signal measurement. For example, if the selected TX-RX beam pair (which is selected using the at least one radio signal measurement and outcome of the ML model) matches an expected beam pair determined by using the auxiliary task, the at least one radio signal measurement is labeled with the LOS outcome. Alternatively, or additionally, the outcome may be modified, such that (or, e.g., until) the output of the at least one auxiliary task using at least the modified outcome indicates a successful test (e.g., a match) of the modified outcome. As noted above for example, the verifier entity may iteratively (e.g., repeatedly) apply a selected function f to the outcome (or carry out a search) to generate the modified outcome, which is then verified via the auxiliary task. If the verification of the modified outcome is successful, the modified outcome is then used as a label for the at least one radio signal measurement (which may be transmitted at 558). The at least one auxiliary task may comprise at least one task having an input of the at least one of the outcomes and/or the at least one radio signal measurement.

Alternatively, or additionally, the at least one auxiliary task may comprise a plurality of auxiliary tasks that are used by the verifier entity. When this is the case, the plurality of auxiliary tasks may be used in combination by the verifier entity to validate (e.g., cross-validate) the outcome to determine the label for the at least one radio signal measurement.

Alternatively, or additionally, in the case the determining, by the verifier entity, the at least one radio signal measurement is to be discarded, the verifier entity may transmit the at least one radio signal measurement to another network node, such as the first network node or the second network node to enable use in a semi-supervised training procedure.

At 558, the verifier entity may transmit the label and the at least one radio signal measurement to the first network node or the second network node to train the machine-learning model for the primary task. Referring again to the example of FIG. 1 at 170A, FIGS. 2-3 at 9, the verifier entity 154 may transmit the at least one radio signal measurement labeled with the outcome.

Alternatively, or additionally, the user entity may be comprised in or comprise a user equipment. Alternatively, or additionally, the trainer entity may be comprised in or comprise a location management function. Alternatively, or additionally, the primary task of the inference of the ML model may comprise a position estimation, a line of sight estimation/detection of a signal source, and/or a beam selection.

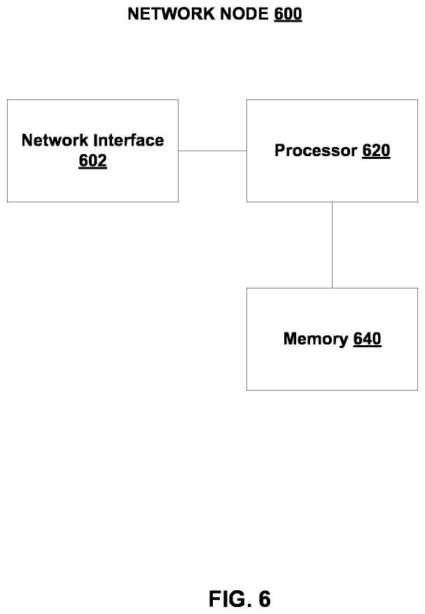

FIG. 6 depicts a block diagram of a network node 600, in accordance with some example embodiments. The network node 600 may comprise or be comprised in one or more network side nodes or functions (e.g., gNB, eNB, DU, TRPs, LMF, LMC, and/or the like).

The network node 600 may comprise a network interface 602, a processor 620, and a memory 604, in accordance with some example embodiments. The network interface 602 may comprise wired and/or wireless transceivers to enable access other nodes including base stations, other network nodes, the Internet, other networks, and/or other nodes. The memory 604 may comprise volatile and/or non-volatile memory including program code, which when executed by at least one processor 620 provides, among other things, the processes disclosed herein with respect to the trainer entity, verifier, and/or the like.

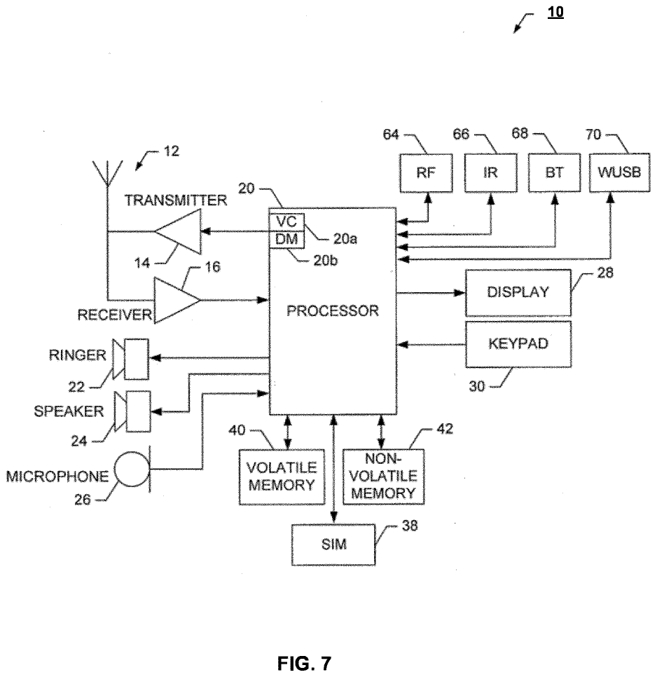

FIG. 7 illustrates a block diagram of an apparatus 10, in accordance with some example embodiments. The apparatus 10 may comprise or be comprised in a user equipment, such as user equipment (e.g., user entity, PRUs, etc.). In general, the various embodiments of the user equipment 204 can comprise cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and aerial vehicles such as manned or unmanned aerial vehicle and as well as portable units or terminals that incorporate combinations of such functions. The user equipment may comprise or be comprised in an IoT device, an Industrial IoT (IIoT) device, and/or the like. In the case of an IoT device or IToT device, the UE may be configured to operate with less resources (in terms of for example power, processing speed, memory, and the like) when compared to a smartphone, for example.

The apparatus 10 may comprise at least one antenna 12 in communication with a transmitter 14 and a receiver 16. Alternatively transmit and receive antennas may be separate. The apparatus 10 may also comprise a processor 20 configured to provide signals to and receive signals from the transmitter and receiver, respectively, and to control the functioning of the apparatus. Processor 20 may be configured to control the functioning of the transmitter and receiver by effecting control signalling via electrical leads to the transmitter and receiver. Likewise, processor 20 may be configured to control other elements of apparatus 10 by effecting control signalling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 7 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may comprise signalling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may comprise speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, sixth-generation (6G) communication protocols, Internet Protocol Multimedia Subsystem (IMS) communication protocols (for example, session initiation protocol (SIP) and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may comprise circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may comprise functionality to operate one or more software programs, which may be stored in memory. In general, processor 20 and stored software instructions may be configured to cause apparatus 10 to carry out actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, comprise a touch sensitive display, where a user may touch and/or gesture to make selections, enter values, and/or the like. The processor 20 may also comprise user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may comprise a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 7, apparatus 10 may also comprise one or more mechanisms for sharing and/or obtaining data. For example, the apparatus 10 may comprise a short-range radio frequency (RF) transceiver and/or interrogator 64, so data may be shared with and/or obtained from electronic devices in accordance with RF techniques. The apparatus 10 may comprise other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may comprise other removable and/or fixed memory. The apparatus 10 may comprise volatile memory 40 and/or non-volatile memory 42. For example, volatile memory 40 may comprise Random Access Memory (RAM) including dynamic and/or static RAM, on-chip or off-chip cache memory, and/or the like. Non-volatile memory 42, which may be embedded and/or removable, may comprise, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may comprise a cache area for temporary storage of data. At least part of the volatile and/or non-volatile memory may be embedded in processor 20. The memories may store one or more software programs, instructions, pieces of information, data, and/or the like which may be used by the apparatus for carrying out operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE, such as the user entity.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may comprise a process for increasing an amount of ML training data with a network-aided self-labelling process to increase the amount and/or diversity of training data to train the ML model.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may comprise implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) comprise machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may comprise a processor and a memory coupled to the processor. The memory may comprise one or more programs that cause the processor to carry out or execute one or more of the operations described herein.

Although a few variations have been described in detail above, other modifications or additions are possible. In particular, further features and/or variations may be provided in addition to those set forth herein. Moreover, the implementations described above may be directed to various combinations and sub combinations of the disclosed features and/or combinations and sub combinations of several further features disclosed above. Other embodiments may be within the scope of the following claims.

If desired, the different functions discussed herein may be carried out in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” comprises “based on at least.” The use of the phase “such as” means “such as for example” unless otherwise indicated.

1. A method comprising:
receiving, by a verifier entity and from a first network node, a configuration for at least labelling at least one radio signal measurement;
receiving, by the verifier entity and from a second network node, information indicating at least one outcome of an inference of a machine learning model for a primary task associated with the at least one radio signal measurement;
carrying out, by the verifier entity, at least one auxiliary task using at least the at least one outcome indicated in the received information;
determining, by the verifier entity and using at least one output of the at least one auxiliary task, a label for the at least one radio signal measurement associated with the at least one outcome, or
determining, by the verifier entity and based on the at least one output of the at least one auxiliary task, the at least radio signal measurement associated with the at least one outcome is to be discarded; and
transmitting the label and the at least one radio signal measurement to the first network node or the second network node to update the machine-learning model for the primary task.

2. The method of claim 1, wherein the carrying out, by the verifier entity, further comprises:
modifying the at least one outcome, such that the output of the at least one auxiliary task using at least the modified outcome indicates a successful test of the modified outcome with the at least one radio signal measurement, wherein the modified outcome is used as the label for the at least one radio signal measurement.

3. The method of claim 1, wherein the at least one auxiliary task comprises at least one machine learning task and/or at least one non-machine learning task.

4. The method of claim 1, wherein the at least one auxiliary task comprises at least one task that uses, as input, the at least one outcome and/or the at least one radio signal measurement.

5. The method of claim 1, wherein the at least one auxiliary task comprises a plurality of auxiliary tasks, and wherein the plurality of auxiliary tasks are used in combination by the verifier entity to verify the at least one outcome to determine the label for the at least one radio signal measurement.

6. The method of claim 1, wherein the configuration for at least labelling at least one radio signal measurement further comprises at least one of: an indication of whether the at least one radio signal measurement is to be labelled; a configuration for the receiving the information indicating the outcome; information on the at least auxiliary task; and a configuration for transmitting the set comprising the label and the at least one radio signal measurement to the trainer entity.

7. The method of claim 1, wherein the verifier entity is comprised in or comprises a network node (the first network node or the second network node), a server, host, or a system controlled by a user device.

8. The method of claim 1, wherein the determining, by the verifier entity, the at least one radio signal measurement to be discarded further comprises transmitting the at least one radio signal measurement to the first network node or the second network node for a semi-supervised training procedure.

9. The method of claim 1, wherein the primary task comprises: position estimation, a line of sight estimation/detection of a signal source, or a beam selection.

10. An apparatus comprising:
at least one processor; and
at least one memory including computer program code, the at least one memory and the computer program code configured to, with the at least one processor, cause the apparatus to at least:
receive, from a first network node, a configuration for at least labelling at least one radio signal measurement;
receive, from a second network node, information indicating at least one outcome of an inference of a machine learning model for a primary task associated with the at least one radio signal measurement;
carry out at least one auxiliary task using the at least one the outcome indicated in the received information;
determine, using at least one output of the at least one auxiliary task, a label for the at least one radio signal measurement associated with the at least one outcome, or
determine, based on the at least one output of the at least one auxiliary task, the at least radio signal measurement associated with the at least one outcome is to be discarded; and
transmit the label and the at least one radio signal measurement to the first network node or the second network node to update the machine-learning model for the primary task.

11. The apparatus of claim 10, wherein the apparatus is further caused to at least: modify the at least one outcome, such that the output of the at least one auxiliary task using at least the modified outcome indicates a successful test of the modified outcome with the at least one radio signal measurement, wherein the modified outcome is used as the label for the at least one radio signal measurement.

12. The apparatus of claim 10, wherein the at least one auxiliary task comprises at least one machine learning task and/or at least one non-machine learning task.

13. The apparatus of claim 10, wherein the at least one auxiliary task comprises at least one task that uses, as input, at least one of the at least one outcome or the at least one radio signal measurement.

14. The apparatus of claim 10, wherein the at least one auxiliary task comprises a plurality of auxiliary tasks, and wherein the plurality of auxiliary tasks are used in combination by the verifier entity to verify the outcome to determine the label for the at least one radio signal measurement.

15. The apparatus of claim 10, wherein the configuration for at least labelling at least one radio signal measurement further comprises at least one of: an indication of whether the at least one radio signal measurement is to be labelled; a configuration for the receiving the information indicating the outcome; information on the at least auxiliary task; and a configuration for transmitting the set comprising the label and the at least one radio signal measurement to the trainer entity.

16. The apparatus of claim 10, wherein the verifier entity is comprised in or comprises a network node (the first network node, or the second network node, or a third network node), a server, host, or a system controlled by a user device.

17. The apparatus of claim 10, wherein the determining, by the verifier entity, the at least one radio signal measurement to be discarded further comprises transmitting the at least one radio signal measurement to the first network node or the second network node for a semi-supervised training procedure.

18. The apparatus of claim 10, wherein the primary task comprises one of a position estimation, a line of sight estimation/detection of a signal source, or a beam selection.

19. (canceled)

20. (canceled)
